(19) United States
(12) Patent Application Publication
(10) Pub. No.: US 2009/0057271 A1
(43) Pub. Date: Mar. 5, 2009

(54) MANUFACTURING METHOD OF METAL INTERCONNECTION

(75) Inventor: I-Chern Kao, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: POWERCHIP SEMICONDUCTOR CORP., Hsinchu (TW)

(21) Appl. No.: 12/025,060

(22) Filed: Feb. 4, 2008

(30) Foreign Application Priority Data
Sep. 5, 2007 (TW) 96133054

(51) Int. Cl. C23F 1/00; B05D 5/12

(52) U.S. Cl. 216/89; 427/96.8

(57) ABSTRACT

A manufacturing method of a metal interconnection is provided. A dielectric layer having an opening therein is formed on a substrate and a barrier layer is then formed on the dielectric layer by performing an ALD process. An Al layer and an Al/Cu layer are formed on the substrate by performing a chemical vapor deposition process and a physical vapor deposition process sequentially, and the Al/Cu layer fills the opening through hot-reflow. A metal line and a plug are formed at the same time after patterning the metal layers and the barrier layer by photolithography and etching processes. Alternatively, the metal layers and the barrier layer outside the opening are removed by a chemical mechanical process, so as to form a plug. The manufacturing method simplifies the processes of forming the metal interconnection and is adapted to the metal interconnection having the opening at a relatively high aspect ratio.

### CROSS-REFERENCE TO RELATED APPLICATION

This application claims the priority benefit of Taiwan application serial no. 96133054, filed on Sep. 5, 2007. The entirety of the above-mentioned patent application is hereby incorporated by reference herein and made a part of this specification.

### BACKGROUND OF THE INVENTION

1. Field of the Invention

The present invention relates to a manufacturing method of a metal interconnection, and more particularly, to a manufacturing method of a metal interconnection by performing an atomic layer deposition (ALD) process for depositing tungsten (W) or tungsten/tungsten nitride (W/WN) to form a barrier layer.

2. Description of Related Art

With advancement of semiconductor technologies, dimensions of the semiconductor devices have continuously miniaturized. As integrity of integrated circuits (ICs) is up to a certain level, a wafer surface is no longer sufficient for forming an interconnection thereon. Hence, a multi-level metal interconnection is adopted in current very-large scale integrated (VLSI) circuits.

Aluminum (Al), copper (Cu), and tungsten (W) are the most commonly applied metal materials in a manufacturing process of the multi-level metal interconnection. Al has great electrical conductivity. However, due to the fact that a spiking effect may occur between Al and silicon materials, Al mainly serves as a metal line utilized among devices. In most cases, Al is deposited by implementing a magnetron DC sputtering process. Besides, W can be fabricated by performing a chemical vapor deposition (CVD) process. Moreover, W is apt to be transformed into tungsten fluoride which has relatively favorable volatility and is easily to be etched. Consequently, W has been extensively applied as plugs among various metals by a number of semiconductor manufacturers. However, the spiking effect is likely to occur on a contact interface between Al and silicon, and W is not very much likely to be adhered to other materials. Based on the above, when Al and W are used, a conductive material (e.g. titanium nitride (TiN) and tungsten nitride (TiW)) as a barrier layer is added between Al, W and other materials, so as to prevent the spiking effect from occurring on the contact interface between Al and silicon and to improve adhesion between W and other materials.

On the other hand, resistance of Cu is lower than that of Al, and electromigration resistance of Cu is greater than that of Al. Thus, Cu has been gradually considered as a replacement for Al. Nevertheless, in the manufacturing process of the metal interconnection, Cu has relatively fast diffusion and better oxidation, and thus the aforesaid problematic properties of Cu should be taken into account. Various metal nitrides and metal oxides may be employed to resolve said problems; however, an increased number of metal processing and complexity of sheet resistance would be expected in the manufacturing process of Cu interconnection.

Conventionally, a manufacturing process of the metal interconnection utilizes a combination of a W plug and an Al/Cu alloy conductive line. In the conventional manufacturing process of the metal connection, a titanium/titanium nitride (Ti/TiN) barrier layer is firstly formed in a plug opening by performing a self-ionized plasma (SIP) physical vapor deposition (PVD) process. Next, the W plug completely filling the plug opening is formed. Thereafter, an Al/Cu alloy layer is deposited by performing the PVD process and is patterned, so as to form a metal line. However, the step coverage of the Ti/TiN barrier layer formed by performing the SIP PVD process and that of the Al/Cu alloy layer formed by performing the PVD process are unfavorable, and thus the conventional manufacturing method is not adapted to openings having aspect ratios higher than 5. Moreover, discontinuity structures are apt to be generated in the Al/Cu alloy layer, which is likely to pose an impact on conductivity of the metal interconnection. Further, the conventional manufacturing process of the metal interconnection is rather complicated.

### SUMMARY OF THE INVENTION

The present invention is directed to a manufacturing method of metal interconnection. In the manufacturing method, an ALD process is carried out, so as to form a barrier layer on a dielectric layer. Thereby, the step coverage of the barrier layer is increased, and the manufacturing method is adapted to the metal interconnection having structures at comparatively high aspect ratios.

The present invention is further directed to a manufacturing method of metal interconnection. In the manufacturing method, W or W/WN is adopted to form a barrier layer. Since the barrier layer serves as a conductive matrix of Al, the manufacturing method is conducive to subsequently performing a CVD process for depositing an Al layer.

The present invention provides a manufacturing method of a metal interconnection. In the manufacturing method, a dielectric layer having an opening therein is formed on a substrate, and a barrier layer is formed on the dielectric layer by performing an ALD process. Thereafter, a metal layer is formed on the substrate, and the metal layer completely fills the opening.

According to an embodiment of the present invention, a material of the barrier layer is W or W/WN, for example.

According to an embodiment of the present invention, the steps of forming a first metal layer on the substrate include performing a CVD process, for example. Next, a second metal layer is formed on the first metal layer by performing a PVD process. Thereafter, a hot re-flow process is implemented, such that the second metal layer completely fills the opening.

According to an embodiment of the present invention, a material of the first metal layer is Al, for example.

According to an embodiment of the present invention, a material of the second metal layer is Al/Cu, for example.

According to an embodiment of the present invention, the opening is a damascene opening, a dual damascene opening, a trench for a metal line, a via hole for a plug, or a contact hole, for example.

According to an embodiment of the present invention, the manufacturing method of the metal interconnection further includes patterning the metal layer and the barrier layer, so as to form a metal line.

According to an embodiment of the present invention, the manufacturing method of the metal interconnection further includes removing the metal layer and the barrier layer outside the opening. The method of removing the metal layer and the barrier layer outside the opening includes implementing a chemical mechanical polishing (CMP) process.

The present invention further provides a manufacturing method of a metal interconnection. In the manufacturing method, a dielectric layer having an opening therein is firstly formed on a substrate and a barrier layer is then formed on the dielectric layer. Here, a material of the barrier layer is W or W/WN, for example. Next, a first metal layer and a second metal layer are sequentially formed on the substrate, and a hot re-flow process is then implemented, such that the second metal layer completely fills the opening.

According to another embodiment of the present invention, the step of forming the barrier layer includes performing an ALD process.

According to another embodiment of the present invention, the step of forming the first metal layer on the substrate includes performing a CVD process, for example.

According to another embodiment of the present invention, the step of forming the second metal layer on the first metal layer includes performing a PVD process, for example.

According to another embodiment of the present invention, a material of the first metal layer is Al, for example.

According to another embodiment of the present invention, a material of the second metal layer is Al/Cu, for example.

According to another embodiment of the present invention, the opening is a damascene opening, a dual damascene opening, a trench for a metal line, a via hole for a plug, or a contact hole, for example.

According to another embodiment of the present invention, the manufacturing method of the metal interconnection further includes patterning the second metal layer, the first metal layer and the barrier layer, so as to form a metal line.

According to another embodiment of the present invention, the manufacturing method of the metal interconnection further includes removing the second metal layer, the first metal layer and the barrier layer outside the opening. Here, the step of removing the second metal layer, the first metal layer and the barrier layer outside the opening includes performing a CMP process, for example.

In the present invention, the ALD process is performed to construct the W or W/WN barrier layer, so as to improve the step coverage of the barrier layer, and thus the manufacturing method provided in the present invention is adapted to the interconnection having the structures at the relatively high aspect ratios. Further, W or W/WN may serve as the conductive matrix of an Al layer, which is conducive to subsequently performing the CVD process for depositing the Al layer.

Moreover, in the present invention, after the hot re-flow process is firstly performed to thoroughly fill the opening with Al/Cu, the metal layer and the barrier layer are directly patterned. Thereby, the plug and the metal line are simultaneously fabricated, simplifying the manufacturing process of the metal interconnection.

In order to make the aforementioned and other objects, features and advantages of the present invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. FIGS. 1A through 1D are cross-sectional views illustrating a manufacturing process of a metal interconnection according to an embodiment of the present invention.

FIG. 1E is a cross-sectional view illustrating a manufacturing process of a metal interconnection according to another embodiment of the present invention.

### DESCRIPTION OF EMBODIMENTS

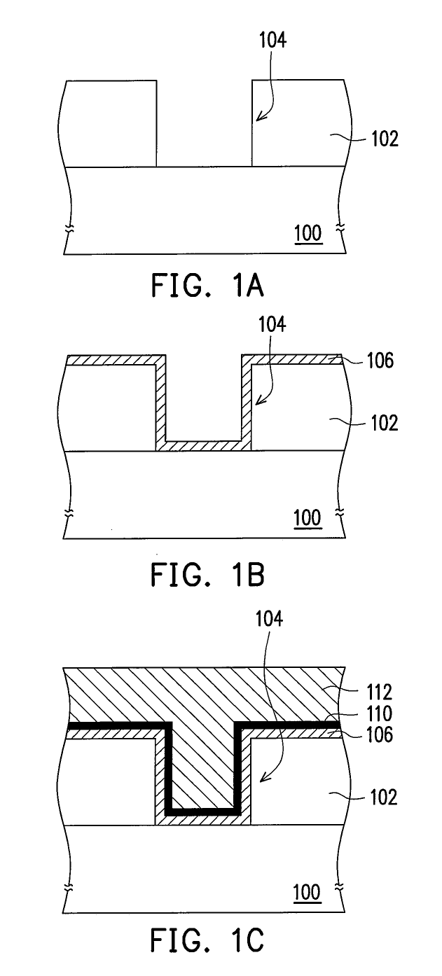

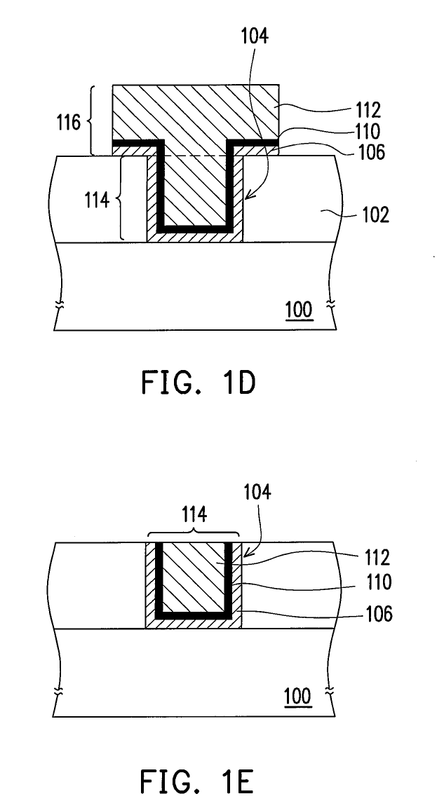

FIGS. 1A through 1D are cross-sectional views illustrating a manufacturing process of a metal interconnection according to an embodiment of the present invention. FIG. 1E is a cross-sectional view illustrating a manufacturing process of a metal interconnection according to another embodiment of the present invention.

Referring to FIG. 1A, a substrate 100 such as a silicon substrate is provided at first. Thereafter, a dielectric layer 102 is formed on the substrate 100. A material of the dielectric layer 102 includes boron phosphorous silicon glass, phosphorous silicon glass, silicon oxide, or other low dielectric constant (low-k) materials (k<4), for example. The low-k materials include inorganic materials, such as hydrogen silsesquioxane (HSQ) or fluorinated silicate glass (FSG), or organic materials, such as fluorinated poly-(arylene ether), Flare), poly-(arylene ether), SiLK) or parylene. The method of forming the dielectric layer 102 includes performing a CVD process or a spin coating process, for example.

Next, an opening 104 is formed in the dielectric layer 102. The method of forming the opening 104 includes, for example, performing a photolithography process and an etching process. In the present embodiment, the opening 104 formed by the aforesaid manufacturing method has a metal damascene structure. Certainly, the opening 104 may also be a dual damascene opening, a trench for a metal line, a via hole for a plug, a contact hole, or the like.

Referring to FIG. 1B, a barrier layer 106 is formed on the dielectric layer 102. The method of forming the barrier layer 106 includes performing an ALD process, for example. A material of the barrier layer 106 is W or W/WN, for example. The barrier layer 106 serves as a buffer of silicon in the dielectric layer 102 and a subsequently formed Al layer, so as to avoid occurrence of a spiking effect. Moreover, the barrier layer 106 is able to improve adhesion of the subsequently formed Al layer and is able to be used as a conductive matrix of the Al layer, which is conducive to the formation of a depositional continuity surface of the Al layer. On the other hand, the barrier layer 106 is formed by performing the ALD process, and thus the step coverage of the barrier layer 106 is favorable and is adapted to manufacture the interconnection having structures at relatively high aspect ratios.

After that, as shown in FIG. 1C, a first metal layer 110 is formed on the substrate 100. The method of forming the first metal layer 110 includes performing the CVD process, for example. A material of the first metal layer 110 is Al, for example. Next, a second metal layer 112 is formed on the first metal layer 110. The method of forming the second metal layer 112 includes performing a PVD process, for example. A material of the second metal layer 112 is an Al/Cu alloy, for example. Thereafter, a hot re-flow process is implemented, such that the Al/Cu alloy of the second metal layer 112 re-flows and completely fills the opening 104. A temperature of the hot re-flow process is approximately in a range from 400° C. to 450° C., and a heating period thereof is around 200˜300 seconds. Here, the first metal layer 110 serves as a seed layer for improving the deposition of the second metal layer 112 and for forming a continuous surface during the hot re-flow process. Thereby, the second metal layer 112 completely fills the opening 104 in which no voids may be formed.

Referring to FIG. 1D, the second metal layer 112, the first metal layer 110 and the barrier layer 106 are then patterned, so as to define a metal line 116. The patterning method includes performing the photolithography process and the etching process on the second metal layer 112, the first metal layer 110 and the barrier layer 106, for example. At the time, a plug 114 and the metal line 116 are formed simultaneously.

In another embodiment of the present invention, referring to FIG. 1E, the first metal layer 110, the second metal layer 112 and the barrier layer 106 outside the opening 104 are directly removed, so as to form the plug 114. The method of removing the first metal layer 110, the second metal layer 112 and the barrier layer 106 includes performing a chemical mechanical polishing (CMP) process, for example.

In light of the foregoing, the ALD process is performed in the present invention to deposit W or W/WN, so as to form the barrier layer. Thanks to the outstanding step coverage of the barrier layer, the issue raised by the conventional barrier layer formed by depositing Ti/TiN through the PVD process is resolved. That is to say, the problem arisen from the conventional barrier layer which is not adapted to the interconnection having the structures at the relatively high aspect ratios no longer exists. As a result, the manufacturing method of the metal interconnection in the present invention is adpated to the semiconductor devices having great integrity.

Moreover, the material of the barrier layer is W or W/WN, and a W film is able to be applied as the conductive matrix of the subsequently deposited Al layer, which is conducive to the formation of the depositional continuity surface of the Al layer.

Furthermore, before the Al/Cu alloy layer (the second metal layer) is formed, the Al layer (the first metal layer) formed on the barrier layer gives rise to an improvement of the adhesion of the subsequently formed Al/Cu alloy layer (the second metal layer), so as to achieve the deposition of the continuity surface.

On the other hand, in the present invention, the hot re-flow process is performed to thoroughly fill the opening with Al/Cu, and the metal layer and the barrier layer are then directly patterned. Thereby, the plug and the metal line are simultaneously fabricated, simplifying the manufacturing process of the metal interconnection. By contrast, the conventional manufacturing process requires the plug made of W and the metal line made of the Al/Cu alloy, and thus more than ten manufacturing processes including removing an W layer through the CMP process can be reduced in the manufacturing method of the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A manufacturing method of a metal interconnection, comprising:
providing a substrate;
forming a dielectric layer having an opening therein on the substrate;
forming a barrier layer on the dielectric layer by performing an atomic layer deposition (ALD) process; and
forming a metal layer on the substrate, wherein the metal layer thoroughly fills the opening.

2. The manufacturing method of claim 1, wherein a material of the barrier layer comprises tungsten (W) or tungsten/tungsten nitride (W/WN).

3. The manufacturing method of claim 1, wherein the steps of forming the metal layer on the substrate comprise:
forming a first metal layer on the substrate by performing a chemical vapor deposition (CVD) process;
forming a second metal layer on the first metal layer by performing a physical vapor deposition (PVD) process; and
performing a hot re-flow process, such that the second metal layer completely fills the opening.

4. The manufacturing method of claim 3, wherein a material of the first metal layer comprises aluminum (Al).

5. The manufacturing method of claim 3, wherein a material of the second metal layer comprises aluminum/copper (Al/Cu).

6. The manufacturing method of claim 1, wherein the opening is a damascene opening, a dual damascene opening, a trench for a metal line, a via hole for a plug, or a contact hole.

7. The manufacturing method of claim 1, further comprising patterning the metal layer and the barrier layer, so as to form a metal line.

8. The manufacturing method of claim 1, further comprising removing the metal layer and the barrier layer outside the opening.

9. The manufacturing method of claim 8, wherein the step of removing the metal layer and the barrier layer outside the opening comprises performing a chemical mechanical polishing (CMP) process.

10. A manufacturing method of a metal interconnection, comprising:
providing a substrate;
forming a dielectric layer having an opening therein on the substrate;
forming a barrier layer on the dielectric layer, wherein a material of the barrier layer comprises W or W/WN;
forming a first metal layer on the substrate;
forming a second metal layer on the first metal layer; and
performing a hot re-flow process, such that the second metal layer completely fills the opening.

11. The manufacturing method of claim 10, wherein the step of forming the barrier layer comprises performing an ALD process.

12. The manufacturing method of claim 10, wherein the step of forming the first metal layer on the substrate comprises performing a CVD process.

13. The manufacturing method of claim 10, wherein the step of forming the second metal layer on the first metal layer comprises performing a PVD process.

14. The manufacturing method of claim 10, wherein a material of the first metal layer comprises Al.

15. The manufacturing method of claim 10, wherein a material of the second metal layer comprises Al/Cu.

16. The manufacturing method of claim 10, wherein the opening is a damascene opening, a dual damascene opening, a trench for a metal line, a via hole for a plug, or a contact hole.

17. The manufacturing method of claim 10, further comprising patterning the second metal layer, the first metal layer and the barrier layer, so as to form a metal line.

18. The manufacturing method of claim 10, further comprising removing the second metal layer, the first metal layer and the barrier layer outside the opening.

19. The manufacturing method of claim 18, wherein the method of removing the second metal layer, the first metal layer and the barrier layer outside the opening comprises performing a CMP process.
